(19) United States
(12) Patent Application Publication
(10) Pub. No.: US 2022/0067319 A1
(43) Pub. Date: Mar. 3, 2022

(54) METHODS AND SYSTEMS FOR GENERATING RFID LABELS USING AUTOMATED TAG ENCODING, AND VERIFICATION OF RFID LABELS POST GENERATION

(71) Applicant: FLEXSTR8, INC., El Segundo, CA (US)

(72) Inventors: Eric Casavant, San Diego, CA (US); Ralph Roessler, El Segundo, CA (US)

(21) Appl. No.: 17/468,532

(22) Filed: Sep. 7, 2021

Related U.S. Application Data
(63) Continuation of application No. 17/037,219, filed on Sep. 29, 2020, now abandoned.
Application No. 17/037,219 is a continuation of application No. PCT/US19/24839, filed on Mar. 29, 2019.
(60) Provisional application No. 62/797,142, filed on Jan. 25, 2019.
(60) Provisional application No. 62/649,779, filed on Mar. 29, 2018.

(51) Int. Cl. G06K 7/10; G06K 19/02; G06K 19/06

(52) U.S. Cl. CPC G06K 7/10861; G06K 19/06028; G06K 19/025; G06K 7/10297

(57) ABSTRACT

The present disclosure provides a system and method for generating RFID labels using automated RFID encoding, and verification of RFID labels post generation. In some aspect, generating RFID labels may be done using a label printer and an easy-to-attach RFID encoder. The RFID encoder may include an RFID controller coupled to a network, one or more antennas, a barcode scanner, and one or more optical detectors. As printed RFID labels pass through the label printer, the RFID encoder receives serialization data on the printed labels, which is translated into encode data by the RFID encoder and mask encoded into the RFID labels.

### CROSS-REFERENCE TO RELATED APPLICATIONS

This application is a continuation of U.S. patent application Ser. No. 17/037,219, filed Sep. 29, 2020, which is a continuation of International Patent Application PCT/US19/24839, filed Mar. 29, 2019, which claims priority pursuant to 35 U.S.C. § 119(e) to U.S. Provisional Patent Application Nos. 62/797,142, filed Jan. 25, 2019 and 62/649,779, filed Mar. 29, 2018, the disclosures of all of which are incorporated herein in their entirety,

### FIELD

The present disclosure relates generally to generating RFID labels, and more particularly to generating RFID labels using automated RFID encoding, and verification of RFID labels post generation.

### BACKGROUND

Equipment for facilitating the production of Radio Frequency Identification (RFID) labels are known, which may be used in conjunction with a standard, non-RFID label printer to allow the label printer to otherwise print RFID labels embedded with RFID chips. One example is an RFID encoder known as Flexstr8 Clip-On RFID encoder for the Epson™ 7500 printer by Flexstr8, Inc. (El Segundo, Calif.) that transforms the Epson™ printer into a high-speed RFID printer. Another example is an easy-to-attach RFID encoder described in WO2018/175558 A1, the contents of which are herein incorporated by reference in its entirety. The users of such RFID encoders would need to upload the desired RFID data to the encoder, before RFID labels can be printed by the non-RFID label printer. However, the users of conventional encoders often experience difficulty in uploading such desired RFID data to the encoder.

In particular, conventional encoders need to encode labels coming from the printer while the printing process is occurring. Therefore, encoders need to have a high-level of synchronization with the printing process because encode data is often related to, if not directly translated from print data. However, encoders can have trouble synchronizing with the printing process since label producers typically use well-known graphic label programs to create and print the labels.

Conventional attempts to provide encoding data entail modifying an encoder to fit specifically with the printing label program. This method is functional but has serious disadvantages due to the time necessary to customize an encoder for each printing label program. For example, conventional print software are often not integrated with RFID, and the ones that do have RFID data integrated do not readily integrate with an external encoder. Moreover, different customers may use different label programs, or their own in house versions thereof. For example, graphic label programs can have proprietary rapid raster image processing (RIP) algorithms to speed up the printing process. An encoder has to receive the printing data and provide encoding data to the printer so that the tags are printed with encoded labels.

Therefore, there is a need for an encoder that can plug in with any printing label program and can use any external source, in particular, by deriving the encode data directly from the print data post printing.

### SUMMARY

This summary and the following detailed description should be interpreted as complementary parts of an integrated disclosure, which parts may include redundant subject matter and/or supplemental subject matter. An omission in either section does not indicate priority or relative importance of any element described in the integrated application. Differences between the sections may include supplemental disclosures of alternative embodiments, additional details, or alternative descriptions of identical embodiments using different terminology, as should be apparent from the respective disclosures.

In an aspect, a computer-implemented method for synchronizing a radio frequency identification (RFID) label printing and encoding using a label printer and an RFID encoder communicably connected thereto may include, by one or more processors, scanning an image of a serialization data printed by the label printer on one of a plurality of RFID labels on a moving roll. The method may further include receiving, by the RFID encoder, the serialization data. The method may further include, by the one or more processors, reading a transponder ID (TID) of the one of the plurality of RFID labels on the moving roll. The method may further include, by the one or more processors, transforming the serialization data into an encode data. The method may further include, by the one or more processors, mask encoding the one of the plurality of RFID labels with the encode data, wherein the mask encoding is synchronized with the reading.

The method may further include, prior to the scanning: receiving the serialization data from a user; and printing, by the label printer, the plurality of RFID labels including the image of the serialization data.

In an aspect, the image may be a barcode on the one of the plurality of RFID labels printed by the label printer. In an aspect, the barcode may be a one-dimensional barcode. In another aspect, the barcode may be a two-dimensional barcode. In an aspect, the mask encoding includes encoding an encode data for TID mask into the one of the plurality of RFID labels. In an aspect, the encode data may be EPC data.

The method may further include, by the one or more processors, receiving a barcode offset from a user.

The method may further include, by the one or more processors, providing an ordered list of TIDs in the plurality of RFID labels.

The method may further include, by the one or more processors,determining that the mask encoding of the one of the plurality of RFID labels is not successful. The method may further include, by the one or more processors, recording a tag index of the one of the plurality of RFID labels as bad. The method may further include, by the one or more processors, initiating a bad label process.

The method may be performed by a system or apparatus including one or more processors coupled to a computer memory holding program instructions that when executed by the one or more processors causes the system or apparatus to perform the method.

### BRIEF DESCRIPTION OF THE DRAWINGS

FIG. 1 illustrates an exemplary software-based method of synchronizing print data and encode data according to an embodiment of the present disclosure.

FIG. 2 is a schematic diagram illustrating a hardware and software system for synchronizing print data and encode data according to an embodiment of the present disclosure.

FIG. 3 illustrates an aspect of a hardware and software system for synchronizing print data and encode data according to another embodiment of the present disclosure, which may include an improved means for singulating the first antenna, by using a small, low power, localized “read antenna”, and another large, high power, unlocalized “write antenna.”

FIG. 4 is a flowchart illustrating high level aspects of a method for generating RFID labels, including encoding based on barcode.

FIG. 5 is a flowchart illustrating aspects of a method of synchronizing RFID label encoding by an RFID encoder with barcode data printed by a label printer, using TID masking.

FIG. 6 illustrates an example printing and encoding system in accordance with an embodiment of the present disclosure.

FIG. 7A-7B, 8, and 9 illustrate an example of TID masked (TID-based) encoding using an exemplary RFID encoder, in accordance with an implementation of the present disclosure, where FIGS. 7A and 7B illustrate steps 1 and 2, respectively, and FIGS. 8 and 9 FIG. 9 illustrate steps 3 and 4, respectively.

FIGS. 10-12 are photographs of a working sample of RFID label generation device (which may serve as both the RFID verifier and the RFID encoder, as disclosed herein) in accordance with one or more embodiments of the present disclosure that is communicably connected to a label printer, where FIG. 10 is an isometric view thereof; FIG. 11 is a side view thereof; FIG. 12 is a close-up side view (opposite FIG. 11) thereof.

FIG. 13 shows a diagram of a “read” zone of a conventional encoder.

FIG. 14 shows an exemplary customized antenna design, in accordance with an implementation of the present disclosure.

FIG. 15 illustrates an exemplary method of encoding and marking tag, in accordance with an implementation of the present disclosure.

FIG. 16 illustrates an exemplary system having an exemplary marker, in accordance with an implementation of the present disclosure.

FIG. 17 illustrates an RFID barcode verification device used to validate RFID tags and barcodes on an RFID label post printing thereof, in accordance with an embodiment of the present disclosure.

FIG. 18 illustrates a web server page for user interface generated by the verification device in accordance with an embodiment of the present disclosure.

FIG. 19 is a flow chart illustrating an operation of the verifier device according to an embodiment of the present disclosure, including 3 main phases: Initialization, Running, and Completion.

FIG. 20A-20B are schematic diagrams illustrating an RFID barcode verification device in a correct starting position and an incorrect starting position, respectively, in accordance with an embodiment of the present disclosure.

FIG. 21 is a photograph of a working sample of RFID label verification device in accordance with an embodiment of the present disclosure, illustrating a movable nature of the shielding so that it may be positioned to rest immediately under or proximate to a gap in adjacent labels.

### DETAILED DESCRIPTION

The present disclosure is described with reference to the attached figures, wherein like reference numerals are used throughout the figures to designate similar or equivalent elements. The figures are not drawn to scale and they are provided merely to illustrate the instant disclosure. Several aspects of the disclosure are described below with reference to example applications for illustration. It should be understood that numerous specific details, relationships, and methods are set forth to provide a full understanding of the disclosure. One having ordinary skill in the relevant art, however, will readily recognize that the disclosure can be practiced without one or more of the specific details or with other methods. In other instances, well-known structures or operations are not shown in detail to avoid obscuring the disclosure. The present disclosure is not limited by the illustrated ordering of acts or events, as some acts may occur in different orders and/or concurrently with other acts or events. Furthermore, not all illustrated acts or events are required to implement a methodology in accordance with the present disclosure.

Various examples of the present disclosure provide systems and methods for generating RFID labels using a non-RFID label printer and an easy-to-attach RFID encoder. The RFID encoder comprises an RFID controller coupled to a network, one or more antennas, a label detector, and an RFID reader. In an aspect, the RFID controller receives a packet of reader settings and a packet (array) of encode data. In an aspect, some or all of the reader settings and encode data may be received from a serial communication connection, a WiFi, or other suitable connection, communicably connected with a human machine interface. The antennas may be also be used for encoding in accordance with an embodiment of the present disclosure.

As imprinted labels pass through the non-RFID label printer and the RFID encoder, the label detector (e.g., gap sensor, RFID inlay sensor, etc.) senses RFID chips of the unprinted labels.

In an example, the RFID encoder 102 can be packed into one or more encoder units that are clipped onto the front and back of the non-RFID label printer. As a web of unprinted labels pass through the non-RFID label printer and the RFID encoder, the RFID encoder senses RFID chips of the unprinted labels, and encode RFIDs (data packet) onto the tags (chips).

With respect to the present disclosure, the terms, “RFID label,” and “RFID tag,” “printing label,” and “printing tag,” or “label” and “tag,” respectively, are used interchangeably to refer to a physical RFID tag which hold electronically-stored information. An RFID tag contains an RFID chip equipped with one or more memory banks, and it may operate under a variety of frequencies (e.g., LF/NFC, HF, UHF, etc.).

### Generating RFID Labels Using Automated Tag Encoding

In some aspect, the present disclosure is directed to methods and systems for generating RFID labels using automated tag encoding. For example, in an implementation, the present disclosure relates to synchronizing: a) automated transformation of print data for an RFID label, and b) encoding of RFID label with the encode data. In some aspect, the method of the present disclosure includes using a software executed on a computer to monitor the same resources that hold the print data and the encode data, and combining the print data and the encode data for use by a printer for generating a print label. In another aspect, a mix of hardware and software may be used (e.g., a camera) to capture images of printing labels passing through the printer. In such example, the captured image may be used by the methods and systems of the present disclosure to synthesize an encode data and send the encode data (encoding instructions) to an encoding antenna. In an aspect, the encode data may be an EPC data transformed from a barcode data. In some aspect, the encode data may be an NFC data that is transformed from or based on visual data (e.g., QR code, barcode, etc.). If a label contains both an embedded NFC inlay and a UHF inlay, the methods and systems of the present disclosure may read a barcode, a QR code, etc., and encode either or both the NFC data and the UHF data based thereon. In an aspect, barcode data is a SKU level data (which may not be unique for every item, but may be unique for every SKU). In some aspect, RFID (EPC) is generally an item level data (e.g., unique for every item and SKU). For example, if tags are encoded based on a SKU level barcode, a unique number for serialization may be injected into the EPC, in addition to the barcode. This “serialization” number can either come from counting, or preferably, from a tag TID. In an aspect, the systems and methods of the present disclosure work with a list of TIDs before starting the label printing or encoding process (for masking the encode), whereby the serialization source is made available and may be referenced to serialize the EPC data being encoded with very little overhead during the encode job. In an aspect, a roll data (roll of TIDs) is downloaded for every roll of labels the RFID encoder uses. In some aspect, not only is this roll of TIDs used for masking (further described below), but it may also be used, for example, to easily encode serialization data based on TID. In some aspect, the roll data may store RFID tags that are known to be “bad” (e.g., broken, cannot be read, etc.). For example, roughly 0.5% of tags produced by manufacturers come out “bad” from manufacturing. Conventional RFID printers may not recognize when bad tags are used with them, and stall their label printing or encoding processes on the bad tags. In an aspect, the RFID encoder of the present disclosure may easily process (e.g., printing or encoding) the bad tags, because the RFID encoder of the present disclosure already recognizes the bad tags prior to starting the job , and just alert the user or automatically reprint the tags that are bad.

In another aspect, reader tuning data is used for every roll of labels in accordance with an embodiment of the present disclosure. Conventional RFID printers must be tuned to the media, and if done incorrectly, the incorrect tuning can cause more errors, e.g., slower encoding by the RFID printers. In an aspect, by having this tuning done in the factory and automatically retrieved by the RFID encoder of the present disclosure, the user may rest assured that the optimal settings are always used.

In an aspect, the encode jobs may also be summarized with a report, which can allow the user to trace the serial data that are encoded on every tag.

The methods and systems of the present disclosure thus provide benefits over conventional processes, because label producers may use their existing print techniques and software with minimal new installations and training. The methods and systems of the present disclosure advantageously prevent label producers from having to manually ensure that an encoder works with every external source and print application.

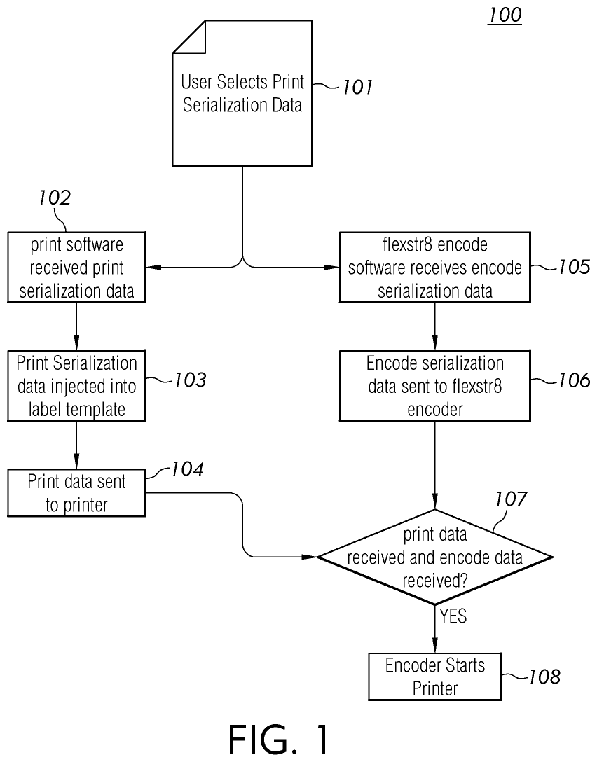

FIG. 1 illustrates an exemplary software-based method 100 of synchronizing print data and encode data according to an embodiment of the present disclosure. The method may begin with a selection of print data by a user at 101. In an aspect, the print data includes the serialization information which constructs a serial code on each label. The selection of print data may include selecting a database or file containing data which populates a serialization data, such as a one-dimensional barcode (e.g., a linear barcode) or a two-dimensional barcode (e.g., Quick Response (QR) code). At 105, in an aspect, the barcode may be synthesized from a raw barcode data residing in a memory bank of the label printer, as it is oftentimes much less in data size compared to an image/RIP data. For example, in an aspect, the method may include downloading a PDF file containing the print data and an XML file containing the encode data from a computer or printer server location such as Avery FTP directories, to process the label print job. As used herein, “job” refers to a print/ encode job, which may include a list of data that needs to be printed/encoded onto blank tags. In an aspect, the selection process may be automated. For example, when a manufacturer registers that “X” garments of “Y” SKU have been made, the label printing may be automatically triggered for those products.

In an aspect according to an embodiment of the present disclosure, at 102, a user may provide the print software with the serialization data to be transformed as encode data for encoding the RFID label, which may be a unique RFID raw data for the RFID label. Some non-limiting examples of the print software include “Bartender,” “NiceLabel,” and “Loftware,” among other print software that a person skilled in the part may find suitable. The user may provide, or identify electronic location of, the barcode raw data and RFID raw data for each label, and the print serialization data is injected into a label template at 103, which is then sent to the printer from the print software at 104.

Alternatively, in another aspect according to another embodiment, the encode data may be derived from the print data. For example, one or a combination of serialization data may be used to calculate the RFID encode data, at 106. During the print process 100, each embedded RFID chip in every label receives the encode data in one or more packets at 108, uniquely identifying that label from all others being printed. The encode software checks whether the print data from 104 and encode data from 106 is received, at 107, and then typically sends the encode data directly to the encoder to start the encoding at 108.

At the same time or close in time to the encode software's receiving and sending of the encode serialization process at 107, the print software can receive print serialization data at 102, inject the data into a label template at 103, and send the print data to a printer at 104.

The method can then check using a printer-encoder communication channel whether both the print data and the encode data have been received, at 107. For example, on an Epson™ C7500 label printer, the method can execute the communication using Esc Label Codes over TCP-IP. The method can complete when the encoder starts the printer at 108.

The method of FIG. 1 can alternatively operate by intercepting print data from the print software, on the print data's pathway to the printer. This can be performed by a complimentary computer application running in the background of a print system. The background application can monitor the actions of the label software and/or intercept data packets to and from the label software and printer.

Alternatively, or in addition, to these methods, another method according to the present disclosure can allow an option in a printing program to both print and encode RFID data. The method can then just intercept the encode data by the printing program when the print/encode job is sent to, or completed by, the printing program. The encoder can then encode the tags with the intercepted data.

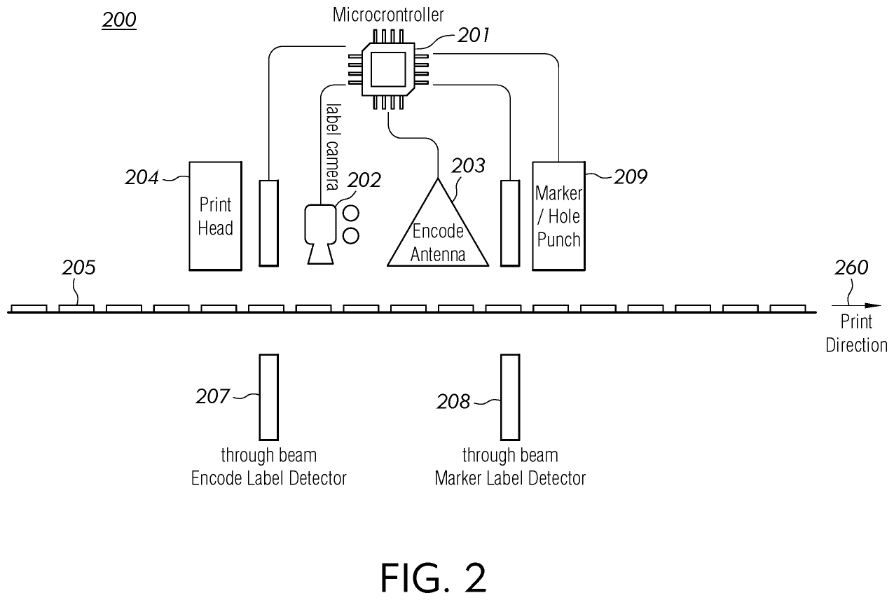

FIG. 2 is a schematic diagram illustrating components of a hardware and software system 200 for synchronizing print data and encode data on RFID labels, according to an embodiment of the present disclosure. All of the electronic computing components of the system 200 described herein are directly or indirectly communicably connected to a microcontroller 201 (e.g., Raspberry Pi). For example, depending o the desired implementation for the exemplary system 200, a variety of networking and messaging protocols can be used, including but not limited to TCP/TP, open systems interconnection (OSI), file transfer protocol (FTP), universal plug and play (UpnP), network file system (NFS), common internet file system (CIFS), AppleTalk etc. As would be appreciated by those skilled in the art, the exemplary system 200 illustrated in FIG. 2 is used for purposes of explanation. Therefore, a network system can be implemented with many variations, as appropriate, yet still provide a configuration of network platform in accordance with various examples of the present disclosure. For instance, in exemplary configuration of FIG. 2, the exemplary system 200 can also include one or more wireless components operable to communicate with one or more electronic devices within a computing range of the particular wireless channel. The wireless channel can be any appropriate channel used to enable devices to communicate wirelessly, such as Bluetooth, cellular, NFC, or Wi-Fi channels. It should be understood that the device can have one or more conventional wired communications connections, as known in the art. Various other elements and/or combinations are possible as well within the scope of various examples. As used herein, “network” refers to any of the foregoing networking or messaging protocol or a component or configuration of components communicably interconnected by such protocol, and “networked” means “having the network connectivity.

The electronic or computing components in the exemplary system 200 can be configured to execute various types of application, and/or can use various types of operating systems. These operating systems can include, but are not limited to, Android, Berkeley Software Distribution (BSD), iPhone OS (iOS), Linux, OS X, Unix-like Real-time Operating System (e.g., QNX), Microsoft Windows, Window Phone, and IBM z/OS. As shown by FIG. 2, in an aspect, a camera 202 may be mounted over the printed labels 205, at a point where the printer output 205 (e.g., a web or roll of imprinted RFID labels) passes through beyond the print head 204 (either inside the printer, or alternatively, outside, at or near the position of the printer output 205 as it exits the printer in whole or in part) and proceeds in the print direction 206. It should be noted that the system 200 may be housed inside the label printer, or it may be attached or communicably connected to the label printer and located outside of the printer. The camera 202 can capture an image of a printed label 205 that has progressed in the print label process and has moved in the print direction 206 beyond the position of the print head 204. In an aspect, a through beam encode label detector 207 may detect that the printed label 205 has progressed beyond the position of the print head 204. The system 200 can then immediately synthesize encode data to encode on the same label 205 as it moves in the print direction 206. The synthesis of the encode data can occur, for example, by (1) using an EPC standard (e.g., GS1 standard) to draw encode data from the print data, (2) using an algorithm provided by a user, or (3) using a lookup table provided by a user. Thereafter, the system 200 can use an encode antenna 203 to encode the label 205.

An exemplary system as depicted by FIG. 2 has advantages over conventional RFID label printing systems, because the camera 202 can also check the quality of the print job and the legibility of the barcode on the printed label 205. In an aspect, a through beam marker label detector 208 can detect that the printed label 205 has progressed in the print direction 206 beyond the encode antenna 203. If a print job is inadequate, a microcontroller 201 can notify a marker 209 that a specific tag 205 can be marked for failure to adequately print a label. In an aspect of the systems of the present disclosure, the marker 209 can also mark the label if the encode antenna 203 detects that the encoding has failed.

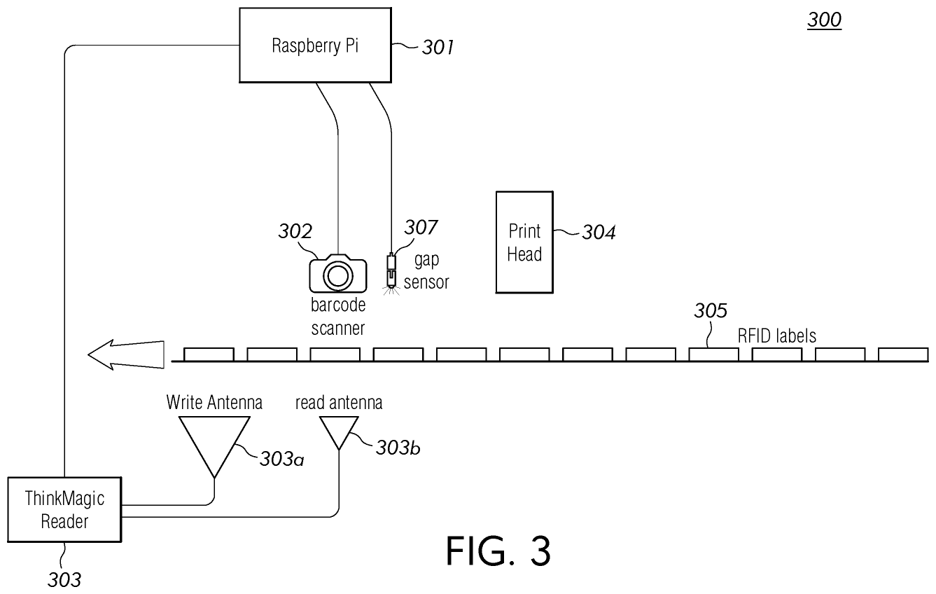

FIG. 3 illustrates an aspect of a hardware and software system for synchronizing print data and encode data according to another embodiment of the present disclosure, namely, a Gen 2 Flexstr8 Encoding System. In an aspect, one of the key advantages of Gen 2 Flexstr8 Encoding System over Gen 1 (as may be described in WO 2018/175558 A1, the contents of which are herein incorporated by reference in its entirety) or any other conventional RFID encoding system is the ability to encode RFID data (EPC) based on barcodes read prior to encoding. In an aspect, the encoding system hardware may be placed along any label print path, and encode passing RFID tags with data based on the printed barcode data.

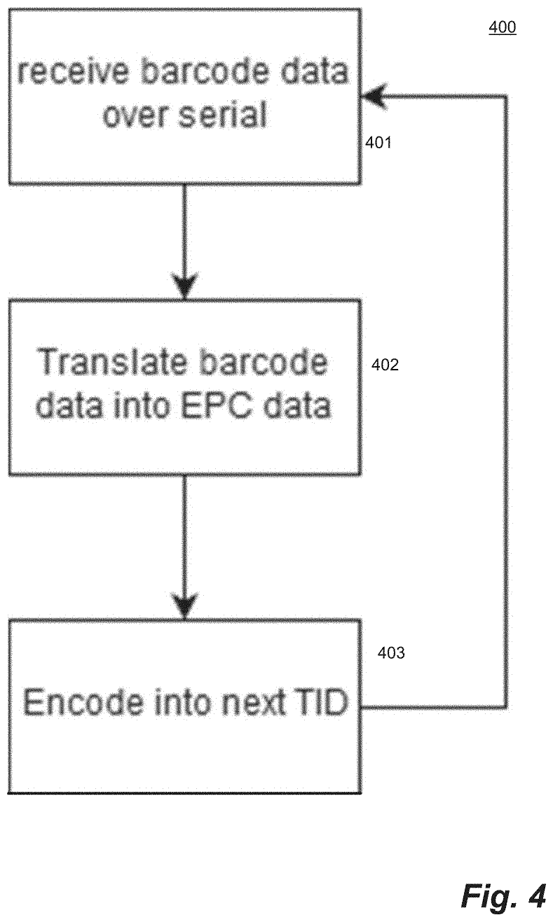

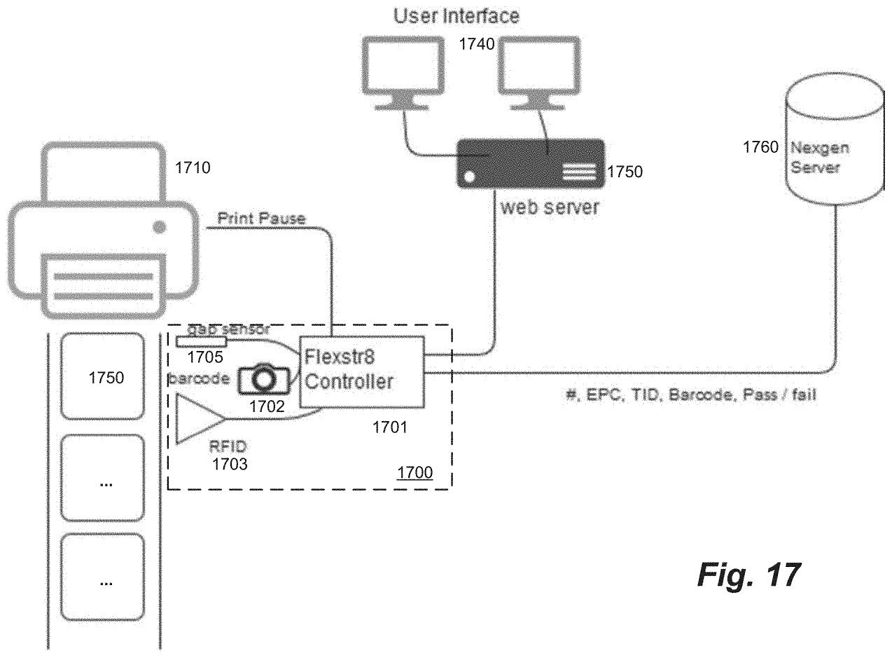

In an aspect, the user of the encoding system according to the present disclosure may control the print and encode jobs from a user interface screen displayed on a computer screen (not shown in FIG. 3; but see, e.g., 1740 in FIG. 17, below, where the user interface 1740 is communicably connected to the Flexstr8 Encoding System 1700 including Flexstr8 Controller 1701, etc., which may include a microcontroller 301 such as Raspberry Pi). By interacting with the encoding system through the user interface, the user may download a print data (e.g., a PDF file) and an encode data (e.g., XML file) from a database (repository) of print and encode data sets (e.g., Avery FTP directories) to process the job. The downloaded print data and encode data may be sent by the microcontroller to a networked RFID reader/encoder 303 (e.g., ThingMagic® Sargas UHF RFID reader/encoder) and a networked printer 304 (e.g., Epson™ ColorWorks C7500) to execute the print and encode job. For example, a web of RFID labels 305 may proceed in the direction of the arrow as the printhead 304 prints print data including barcode data thereon. The barcode scanner 302 may scan the barcode on the RFID label 305, while the RFID read antenna 303b may read the corresponding RFID transponder ID (TID) of the RFID label 305, in order to encode the label with the encode data using an RFID write antenna 303a. Alternatively, the encoder may read the barcode, translate the same to EPC data using the GS1 standard, then encode the tag using a TID mask. In an aspect, all TID masks are provided to the RFID encoder before the job. More details of this synchronized print and encode process will be described with respect to FIGS. 4-9 below.

In an embodiment, the following hardware in the non-exhaustive list below was selected as functional components of the Gen2 Flexstr8 Encoding System:
ThingMagic® Sargas Micro 2-Port UHF RFID Reader,
Datalogic Matrix 120™ Barcode Scanner (although the system should work with any suitable USB serial barcode scanner),
Keyence FS-N11N Label Sensor, and
Flexstr8 Clip-On Plastic Parts.

FIG. 4 is a flowchart illustrating high level aspects of a method 400 for generating RFID labels. At 401, the method includes a processor (e.g., microprocessor 301) receiving a serialization (e.g., barcode) data from a serialization source (e.g., barcode scanner 302 in FIG. 3, or Nexgen server 1760 in FIG. 17, etc.) networked (communicably connected) thereto, over a serial communication or any other suitable network connection. At 402, the method includes a processor translating the barcode data into an encode data (e.g., EPC data). At 403, the method includes encoding, by the processor, the encode data into an RFID chip of an RFID label, which may be identified by TID (e.g., next TID in the ordered list of TIDs to be encoded).

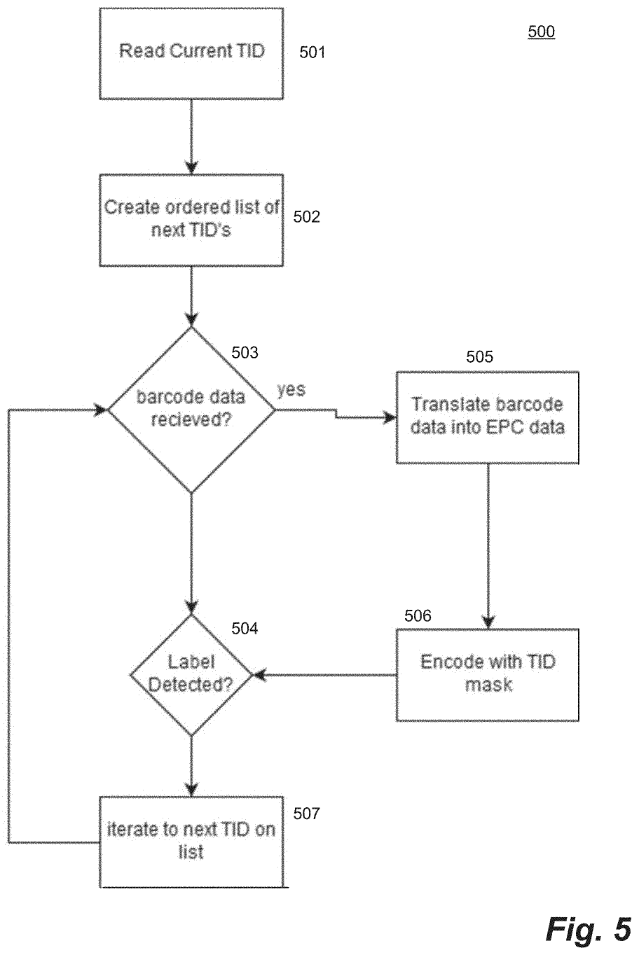

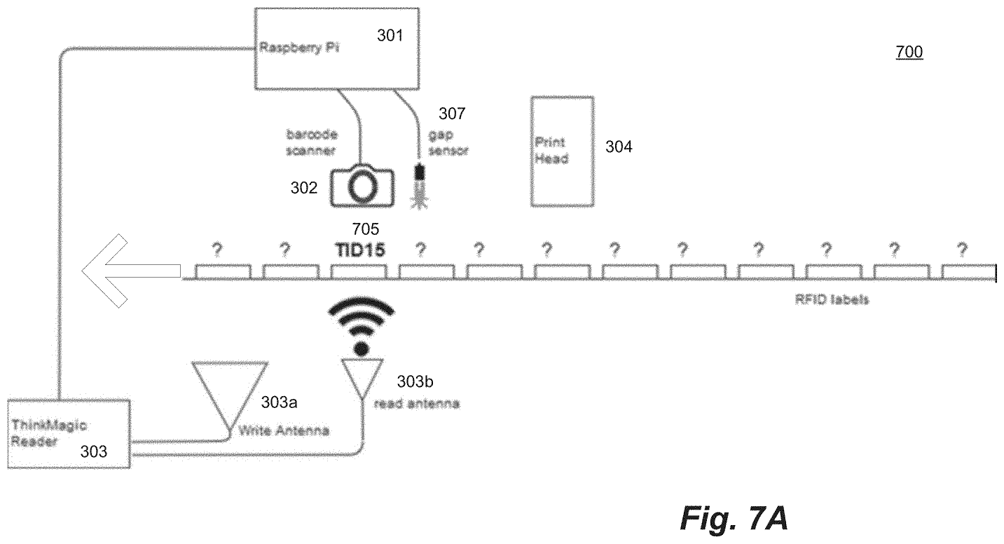

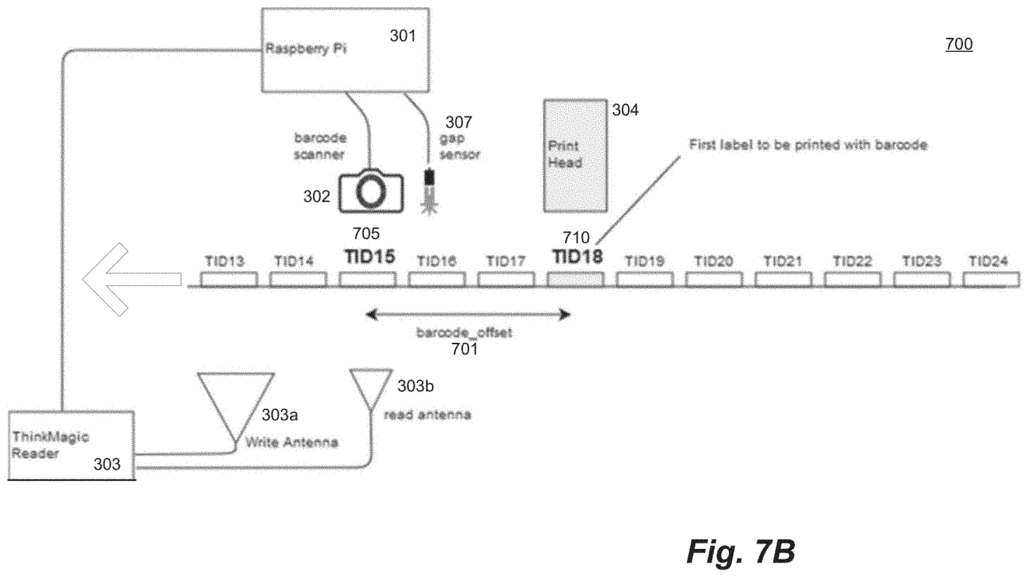

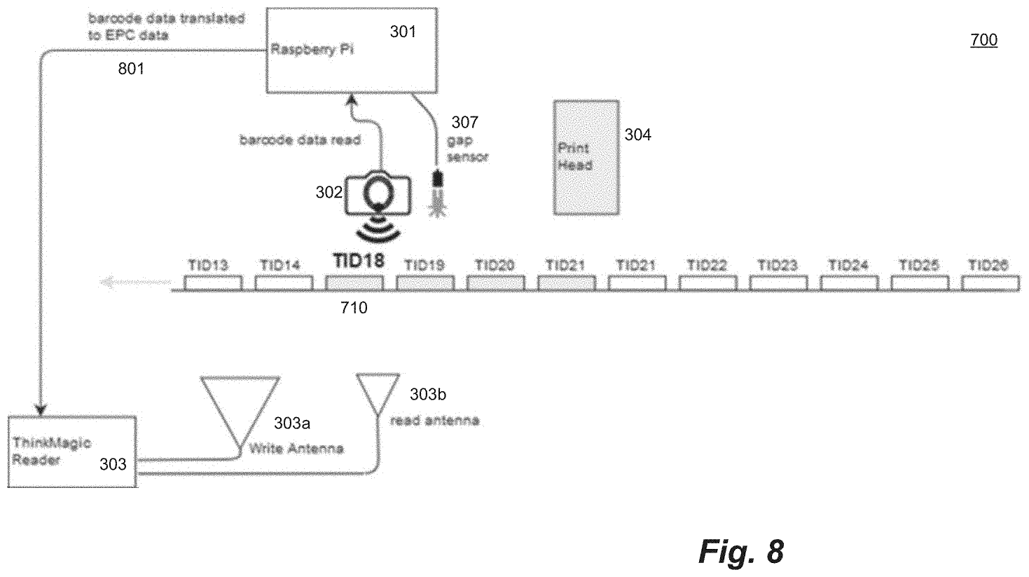

FIG. 5 is a flowchart illustrating aspects of a method 500 of synchronizing RFID label encoding by an RFID encoder with barcode data printed by a label printer, using TID masking from an expected (predefined), ordered list of TIDs in a roll of RFID labels, in accordance with an implementation of the present disclosure. As used herein, “TID” refers to transponder identifier (sometimes also referred to as tag identifier), and a TID number identifies the model and manufacturer of the corresponding RFID chip having the TID number stored thereon. The TID numbers are written on the chips during fabrication and they are protected against rewriting. A TID number can optionally include a serial part that also identifies the unique chip. These serialized TID numbers are written on some existing EPC Class-1 Generation-2 (in short: Gen-2) chips). In an example of the present disclosure (as further illustrated in FIGS. 7A, 7B, and 8-9), the RFID encoder relies on TID filtering and tag mask encoding to ensure accurate, singulated, and high speed encoding. As used herein “tag mask” refers to a string of bits or characters used to select or identify a certain tag, using a starting mask address and a mask length (usually in bits). If the mask (address and length) references a memory location that does not exist on the tag, then the tag will be considered as non-matching. If the mask length is zero, then all tags will be considered matching, unless the starting mask address references a memory location that does not exist. A mask may be applied to data in the TID bank, the EPC bank, or the User memory bank of the RFID chip.

Once a printing job has started, at step 501, an RFID reader/writer of an RFID encoder can determine a current TID of the current tag. At step 502, the RFID encoder is provided with an ordered list of next TID's, which it may create or assemble, or which it may simply be provided by a user for a particular print job. In some implementation, the TID list may be stored on the RFID encoder, a server networked with the encoder, or a cloud. For example, in some aspect, at the start of a job, the read antenna reads the closest TID. In an aspect, the TID may be used as a reference to retrieve all TIDs for the label roll from the cloud, and may be cached in the RFID encoder for future jobs. The encoder may use the next TIDs in sequence in the roll for mask encoding the next tags in the print job. In some aspect, by downloading the roll data above, other information about the roll may also be retrieved, for example, tags known to be bad. Hence, before they are printed on, a label printer may deal with all tags in the roll automatically without ever stopping the print process.

Or, in some implementation, the ordered list of next TID's may be generated by reading TID's on a roll of RFID labels using an RFID reader. At step 503, the RFID encoder determines whether a barcode data of the current tag is received. If no barcode data is received or detected, the method proceeds to step 504, where the RFID encoder determines whether an RFID label is detected. For example, a gap detector may be used to determine whether a label is detected, rather than a gap in between the labels. At step 507, the RFID encoder iterates the process 700 by moving on to the next TID on the TID list. Going back to step 503, if the barcode data is detected, then the method proceeds to step 505, where the RFID encoder translates the received barcode data into an EPC data. At step 506, the RFID encoder encodes the current tag with the TID tag mask including the translated EPC data, and then the method 700 proceeds to step 504.

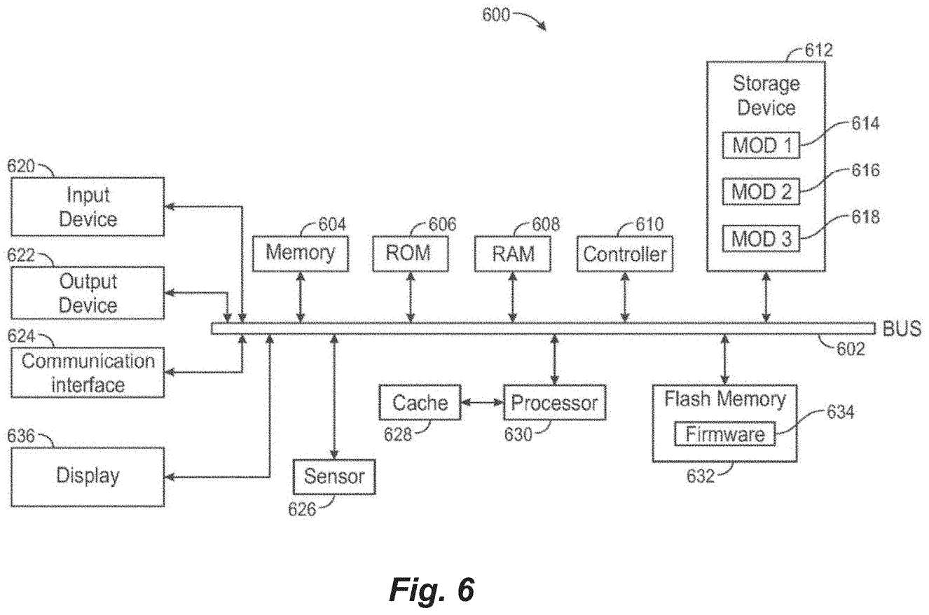

FIG. 6 illustrates an example printing and encoding system 600 in accordance with an embodiment of the present disclosure, in which components of the computing system 600 are in electrical communication with each other using a bus 602. The system 600 includes a processing unit (CPU or processor) 630, and a system bus 602 that couples various system components, including the system memory 604 (e.g., read only memory (ROM) 606 and random access memory (RAM) 608), to the processor 630. The system 600 can include a cache of high-speed memory connected directly with, in close proximity to, or integrated as part of the processor 630. The system 600 can copy data from the memory 604 and/or the storage device 612 to the cache 628 for quick access by the processor 630. In this way, the cache can provide a performance boost for processor 630 while waiting for data. These and other modules can control or be configured to control the processor 630 to perform various actions. Other system memory 304 may be available for use as well. The memory 604 can include multiple different types of memory with different performance characteristics. The processor 630 can include any general purpose processor and a hardware module or software module, such as module 1 64, module 2 616, and module 3 618 embedded in storage device 612. The hardware module or software module is configured to control the processor 630, as well as a special-purpose processor where software instructions are incorporated into the actual processor design. The processor 630 may essentially be a completely self-contained computing system, and containing multiple cores or processors, a bus, memory controller, cache, etc. A multi-core processor may be symmetric or asymmetric.

To enable user interaction with the computing device 600, an input device 620 is provided as an input mechanism. The input device 620 can comprise a microphone for speech, a touch-sensitive screen for gesture or graphical input, keyboard, mouse, motion input, and so forth. In some instances, multimodal systems can enable a user to provide multiple types of input to communicate with the system 300. In this example, an output device 622 and a display 636 are also provided. The communications interface 624 can govern and manage the user input and system output.

Storage device 612 can be a non-volatile memory to store data that are accessible by a computer. The storage device 62 can be magnetic cassettes, flash memory cards, solid state memory devices, digital versatile disks, cartridges, random access memories (RAMs) 608, read only memory (ROM) 306, and hybrids thereof.

The controller 610 can be a specialized microcontroller or processor on the system 600, such as a baseboard management controller. In some cases, the controller 610 can be part of an Intelligent Platform Management Interface (IPMI). Moreover, in some cases, the controller 610 can be embedded on a motherboard or main circuit board of the system 600. The controller 610 can manage the interface between system management software and platform hardware. The controller 610 can also communicate with various system devices and components (internal and/or external), such as controllers or peripheral components, as further described below.

The controller 610 can generate specific responses to notifications, alerts, and/or events, and communicate with remote devices or components (e.g., electronic mail message, network message, etc.) to generate an instruction or command for automatic hardware recover}═ procedures, etc. An administrator can also remotely communicate with the controller 610 to initiate or conduct specific hardware recovery procedures or operations, as further described below.

The controller 610 can also include a system event log controller and/or storage for managing and maintaining events, alerts, and notifications received by the controller 610. For example, the controller 610 or a system event log controller can receive alerts or notifications from one or more devices and components, and maintain the alerts or notifications in a system event log storage component.

Flash memory 632 can be an electronic non-volatile computer storage medium or chip that can be used by the system 600 for storage and/or data transfer. The flash memory 632 can be electrically erased and/or reprogrammed. Flash memory 632 can include EPROM (erasable programmable read-only memory), EEPROM (electrically erasable programmable read-only memory), ROM, NVRAM, or CMOS (complementary metal-oxide semiconductor), for example. The flash memory 632 can store the firmware 634 executed by the system 600, when the system 600 is first powered on, along with a set of configurations specified for the firmware 634. The flash memory 632 can also store configurations used by the firmware 634.

The firmware 634 can include a Basic Input/Output System or equivalents, such as an EFI (Extensible Firmware Interface) or UEFI (Unified Extensible Firmware Interface). The firmware 634 can be loaded and executed as a sequence program each time the system 600 is started. The firmware 634 can recognize, initialize, and test hardware present in the system 600 based on the set of configurations. The firmware 634 can perform a self-test, such as a POST (Power-on-Self-Test), o the system 600. This self-test can test functionality of various hardware components such as hard disk drives, optical reading devices, cooling devices, memory modules, expansion cards, and the like. The firmware 634 can address and allocate an area in the memory 604, ROM 606, RAM 608, and/or storage device 612, to store an operating system (OS). The firmware 634 can load a boot loader and/or OS, and give control of the system 600 to the OS.

The firmware 634 of the system 600 can include a firmware configuration that defines how the firmware 634 controls various hardware components in the system 600. The firmware configuration can determine the order in which the various hardware components in the system 600 are started. The firmware 334 can provide an interface, such as an UEFI, that allows a variety of different parameters to be set, which can be different from parameters in a firmware default configuration. For example, a user (e.g., an administrator) can use the firmware 634 to specify clock and bus speeds; define what peripherals are attached to the system 600; set monitoring of health (e.g., fan speeds and CPU temperature limits); and/or provide a variety of other parameters that affect overall performance and power usage of the system 600. While firmware 634 is illustrated as being stored in the flash memory 632, one of ordinary skill in the art will readily recognize that the firmware 634 can be stored in other memory components, such as memory 604 or ROM 606.

System 600 can include one or more sensors 626. The one or more sensors 626 can include, for example, one or more temperature sensors, thermal sensors, oxygen sensors, chemical sensors, noise sensors, heat sensors, current sensors, voltage detectors, airflow sensors, flow sensors, infrared thermometers, heat flux sensors, thermometers, pyrometers, etc. The one or more sensors 626 can communicate with the processor, cache 628, flash memory 632, communications interface 624, memory 604, ROM 606, RAM 608, controller 610, and storage device 612, via the bus 602, for example. The one or more sensors 626 can a so communicate with other components in the system via one or more different means, such as inter-integrated circuit (I2C), general purpose output (GPO), and the like. Different types of sensors (e.g., sensors 626) on the system 600 can also report to the controller 610 on parameters, such as cooling fan speeds, power status, operating system (OS) status, hardware status, and so forth.

It can be appreciated that example system 600 can have more than one processor (e.g., 630), or be part of a group or cluster of computing devices networked together to provide greater processing capability.

FIGS. 7A, 7B and 8-9 illustrate an example of TID masked (TID-based) encoding using an exemplary RFID encoder, in accordance with an implementation of the present disclosure.

Referring to FIG. 7A, before printing or encoding begins, the system 700 (e.g., at microprocessor 301) receives an ordered list of all TID in a roll/web of RFID labels for encoding, which can be selected by user. When the job starts, the RFID reader 303 may perform a TID read (Step 1) via read antenna 303b can detect and discover which tag (TID)(e.g., tag 705 bearing “TID15”) is directly underneath the barcode scanner 302, and, subsequently, use that information to determine all next TID's to be expected. In an aspect, this TID read, combined with the “barcode offset,” i.e., a user-inputted number of labels between the barcode reader 302 and print head 304 (e.g., barcode offset 701 in FIG. 7B), will allow the RFID encoder 700 to derive the TIDs of the first printed label (with a barcode), and all subsequent TIDs. The RFID encoder 700 can use the list of TID's to encode each tag accurately, which ultimately leaves no chance for duplicate encoding, missed encoding, or a registration error in encoding. For example, in FIG. 7A, Step 1 illustrates a low power TID read that is performed by the RFID reader 303 to find the tag (TID) immediately under the barcode scanner 302. In this example, TID15 is found to be the first tag immediately under the scanner.

Referring to FIG. 7B (Step 2), using the TID immediately under (i.e., singulated to be within the reading range of) the read antenna 303b, and the ordered list of TIDs in the roll, all TIDs in the job are found. The user defined variable, “Barcode Offset,” (e.g., barcode offset 701) defines the number of labels between the read antenna 303b and print head 304. This allows us to determine the TID of the first label printed on, as well as all subsequent label TIDs. In an example as shown in FIG. 7B, the barcode offset is 3 (“Barcode Offset=3”), and the first tag 705 found under the read antenna 303b is TID15. Thus, the first label to be printed with a barcode is now TID18. At this point, the encoder 700 is armed to encode the labels (TID18 and onward), because the TID's for all tags in the print job are known.

Referring to FIG. 8 (Step 3), the print/encode job is started. The first barcode to be translated is read by the barcode scanner 302, and it is known (recognized by the encoder 700) to be on the label 710 bearing TID18. The barcode data on the label 710 (e.g., TID18) captured by the barcode scanner 302 is sent to and translated by the microprocessor 301 into an EPC data, which is then sent to RFID writer 303, such that the EPC data may be encoded onto the same tag (e.g., tag 710 bearing TID18) via RFID antenna 303a.

Referring to FIG. 9 (Step 4), the barcode data on tag 710 bearing TID18, which has been translated into the EPC data, is encoded onto tag 710 (TID18) as the EPC data by the RFID writer 303 via the RFID antenna 303a, using a TID masked encode process 901, such as the process 500 described in FIG. 5 above.

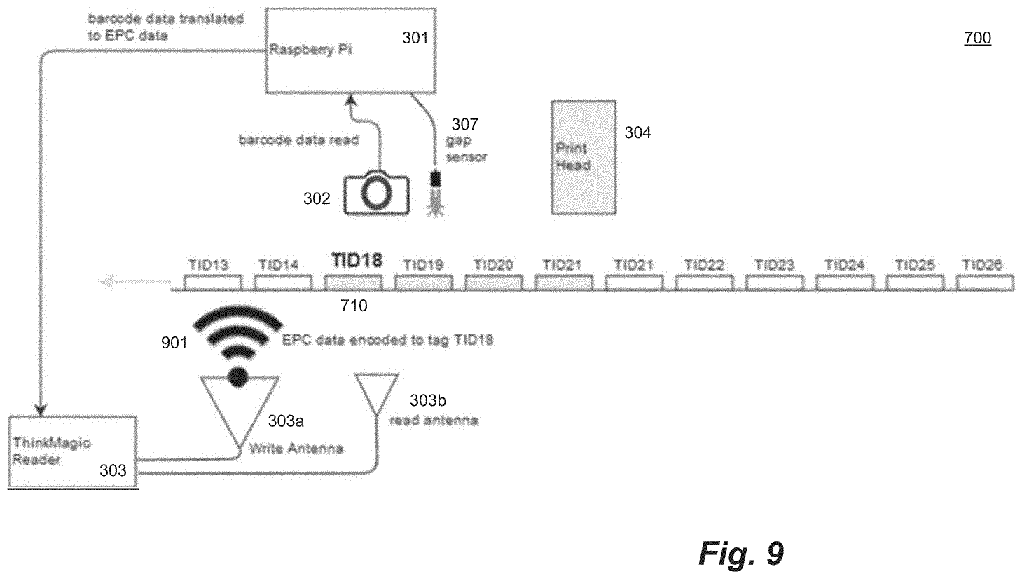

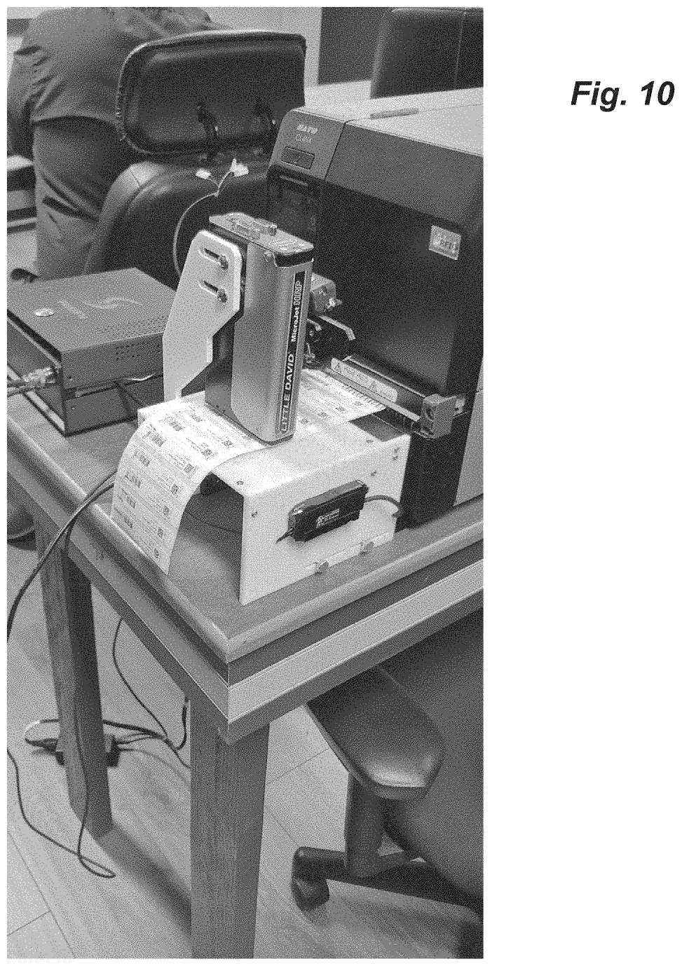

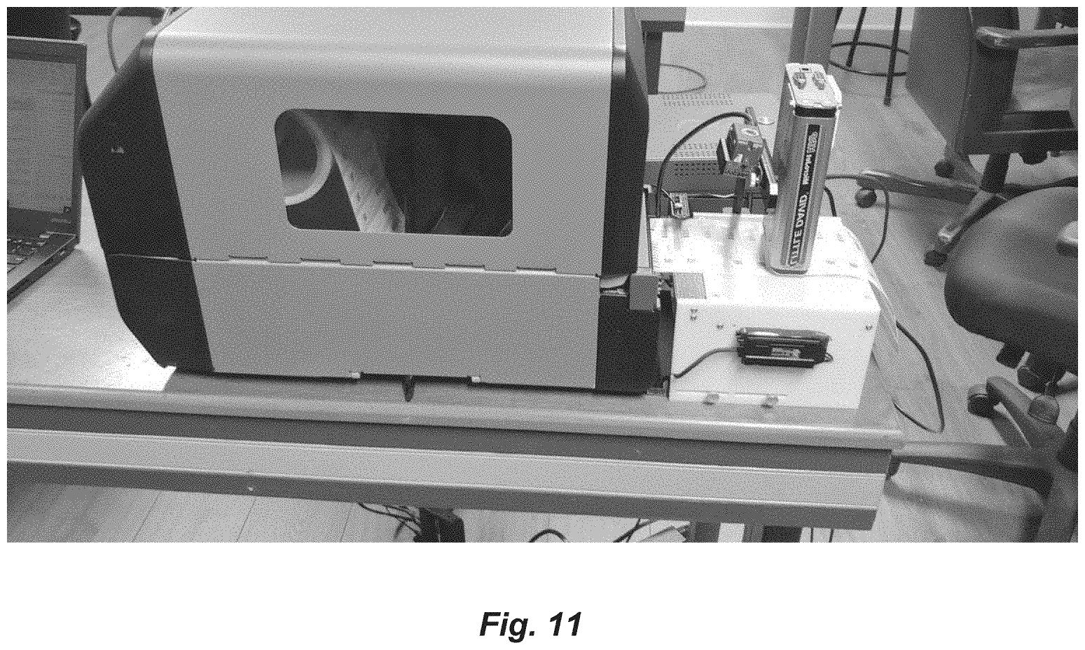

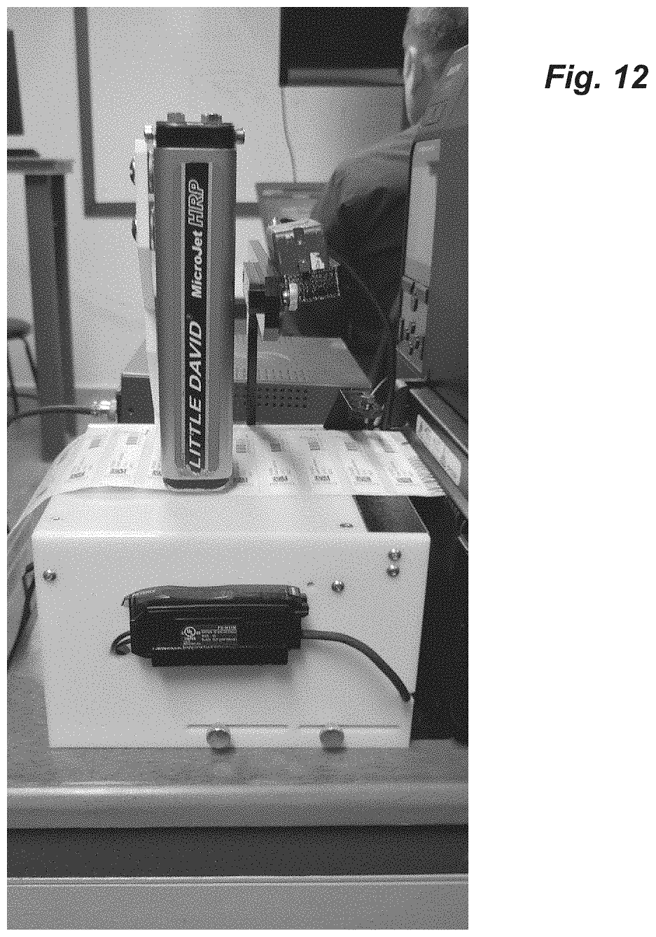

FIGS. 10-12 are photographs of a working sample of RFID label generation device communicably connected to a label printer (.e.g., SATO® CL4NX RFID printer as shown), including a barcode scanner, a print head (Little David® Microjet HRP), RFID antenna, and RF shielding, etc., showing a web of printed labels exiting the printer and sliding between the printhead and the RF shielding. FIG. 10 is an isometric view thereof FIG. 11 is a side view thereof; FIG. 12 is a close-up side view (opposite FIG. 11) thereof.

### Customized Encoder Antenna, and Electric Marker

A principal goal of clip-on encoders is to encode labels coming from the printer with minimal interruption to the printing process. An encoder is at the mercy of the printer to set pace of the encode rate and label speed. Encoding NFC tags have a notoriously slow encoding rate. Current printers have a fast printing rate. This creates a serious mismatch when trying to encode NFC tags with a contemporary, fast printer.

Additionally, there is the problem of identifying tags which were not successfully encoded, also called ‘bad labels’. Contemporary attempts to identify bad labels might use a stand-alone inkjet marker which operates by firing when a bad label reaches the marker. This method is functional, but has serious disadvantages including: (1) the printer's ink needs to be refilled regularly, (2) the print-head of the printer can get clogged by the ink without an operator knowing, and (3) inkjet markers are typically expensive.

Other contemporary attempts to identify bad labels include using an electric power marker (e.g., a hole punch) to mark bad labels. Labels are often made with thick, high strength polymer materials. Commercial hole punches that were suitable for this application were all pneumatically driven, operated by high pressures of air or gas. These pneumatic commercial hole punches are highly expensive as well.

Therefore, what is needed is an effective, cheap methods and systems for encoding and marking tags which does not require upkeep or external maintenance of the system.

In some aspect, the methods and systems of the present disclosure is also directed to reading, encoding and marking moving tags. The present disclosure provides for systems and methods of encoding tags at the fast rate of standard printers. The systems and methods do not require external maintenance in order to mark tags that failed to encode while passing through the printer or encoder.

In an aspect, tags encoded by the printer or encoder of in accordance with a system or method of the present disclosure may be near-field communication (NFC) tags, RFID tags, or any other electronically encoded tags.

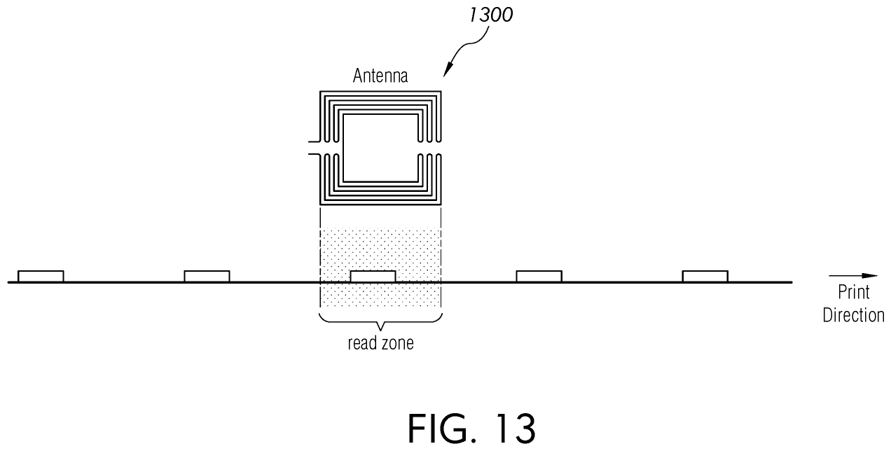

FIG. 13 shows a diagram of a “read” zone of a conventional encoder. This encoder can encode NFC tags, which have a notoriously slow encoding rate. A standard NFC antenna is designed to read and encode stationary tags. Therefore, as a tag moves in the print direction, the tag needs to be paused for underneath the antenna. Antennas in the conventional encoder are designed as small and symmetrical. The corresponding “ read zone” where the tag is encoded can be very small and therefore the tag either needs to be moving very slowly or close to stationary while the tag is being encoded.

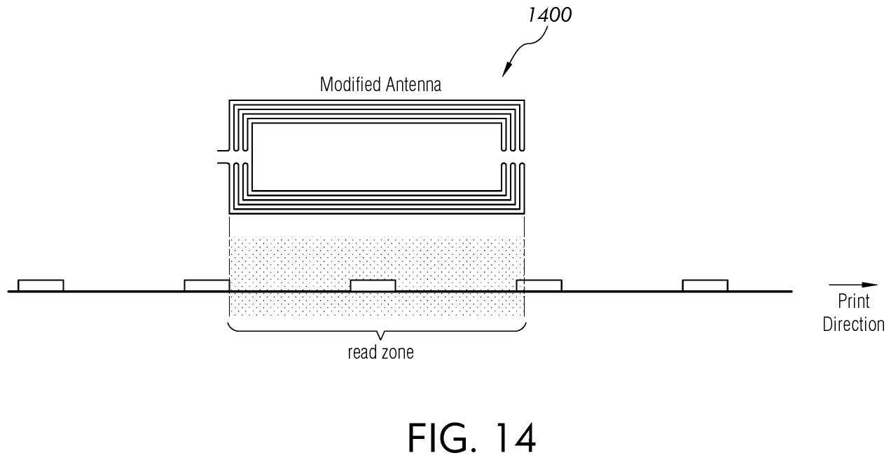

FIG. 14 shows an exemplary customized antenna design of an exemplary encoder system, in accordance with an implementation of the present disclosure. The customized antenna is elongated on the horizontal axis, which is parallel to the print direction of the encoder system. The longer the antenna, the longer the “ read zone.” For example, in an implementation, the NFC antenna may be 120 mm in length, as opposed to a more standard 40 mm length. Therefore, the elongated axis will have a wider “read zone” over the tag. The elongated antenna can be in contact with the tag for a significantly longer period of time than the period of time that a contemporary antenna is in contact with the tag. In an implementation, the contact of the antenna with the tag can be provided by a coil to coil, induction based communication. As long as the tag and read antenna have aligned coils, communication can be established. For example, a long rectangular antenna may generate a long field in one axis, keeping the tag in contact with the reader anywhere along that axis. This exemplary customized antenna displayed in FIG. 14 allows encoding of a tag while the tag is moving in the print direction. The wider “read zone” allows sufficient time for tags to be encoded such that tags can even be encoded while going at a fast speed. For example, in an aspect, the present disclosure may entail the following encoding steps:

Step 1: Tag enters readers B field

Step 2: Induction causes tag to wakeup

Step 3: Tag handshakes with reader, establishing communication

Step 4: Tag 4 gets read/written

Step 5: Tag notifies reader of read/write status (success/failure)

Step 6: Tag exits readers B field, communication is lost, tag powers down (tag is passive)

However, as with all tag encodings, there can still be instances where a tag is not encoded. Clip-on encoders typically encode RFID tags after they have been printed. One disadvantage to this approach is if encoding fails, there is no way to use the printer to mark the bad label; as the bad label is already downstream from the print head.

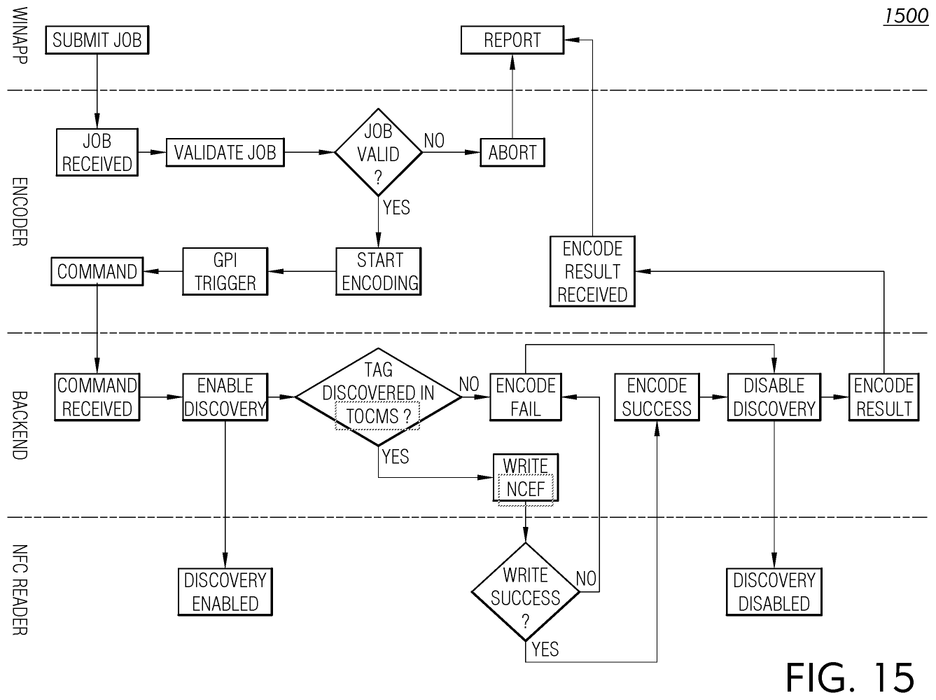

FIG. 15 shows an exemplary method 1500 using an encoder that comprises an encoder reader configured to read or discover a tag, and tag detector configured to identify whether a tag was successfully encoded. This system 1500 operates without help from the printer. If a tag was failed to be encoded, the tag typically has already moved downstream of the printer and encoder.

The encoder is first configured to receive a submitted job, and validates the job. In an aspect, the submitted job refers to a job submitted by a user or a print server. An encode data may be sent separately from the print data, as an array of encode data. The encode data may also be integrated with print data; for example, a PDF can hold encode metadata. Or, the encode data may be derived from barcode data, either from a barcode image, or from raw barcode data that's sent to the printer. In an aspect, validation of a job may include checking that the data is in a format that can be encoded in the tags. In some aspect, a specific tag may be read before encoding. Doing so would allow downloading the TID data, but such method may also be used to determine if the data matches the tag that the encoder is attempting to encode (e.g., there may be many different tag models, which may have varying amounts of data to encode, and different branches of data available). If the job is found to be not valid, then the task is aborted, and the failure is reported with an alert. For example, the job may be found to be invalid if the requested data to encode is: too large (bytes); in a branch not available in the tag (for example, user data—not all tags have a user data branch); with a lock specification that's not available in the tag, etc. In some aspect, the reporting is made to the user and/or a web server/computer. Alerts may include, for example: a screen dialog pop-up, a physical alarm, a physical light, or the like. In some aspect, the encoder may be a microcontroller connected to the internet via LAN and may also be connected to a PLC and/or a printer. For example, the alarm may include: an alarm connected to microcontroller; a red (or any other suitable colored) flashing light communicably connected to the microcontroller; a stop sequence sent to PLC or printer, an alarm sent to a web server that displays an error dialog, an alarm sequence sent to aw eb server that is recorded on a database, etc. If the job is instead found to be valid, then the encoder starts encoding the tag. For example, the encoding may be done with a standard NFC protocol, such as a library call with a licensed NFC reader, with which a microcontroller may communicate via USB, RS232A, or any other suitable communication interface. A general purpose input can be triggered which can provide a command. In general, timing is critically important for maximizing the throughput of a multi-machine process. In an aspect, the present disclosure may include using an optical triggering to notify the NFC encoder of precisely when to attempt encoding (when the tag has just entered the range of the NFC writer antenna). In an aspect, the optical trigger may detect a tag gap and send a digital signal to the microcontroller to indicate such detection.

On the backend of the system, a discovery command (e.g., a standard NFC reader command sent from a microcontroller) can be received and enable a discovery mode. As used herein, “discovery mode” means a mode whereby the NFC reader continually broadcasts a signal, and sits and waits for a response from a tag which has come into the read range. A NFC reader can then discover the tag.

In some aspect, the backend may persistently or continually check whether the tag was discovered in a predefined amount of time, e.g., 100 milliseconds (ms). In an aspect,100 ms was empirically found to work well with a certain type of printer, but it is to be understood that a different value may be more suitable for a different machine. In some implementation, the discovery mode may be triggered automatically when the tag is detected or identified to be within a read range of the antenna. If the tag still has not been read after the predefined amount of time (e.g., 100 ms), the system of the present disclosure may determine that the tag is likely defective. In some aspect, if a tag is detected, but after the predefined amount of time (e.g., 100 ms), the system may determine that the next tag in sequence has entered the antenna read range. If the tag was not discovered, then the encoding will be marked as a failure, the discovery will be disabled (automatically, manually, or both), and a failure may be reported to the encode report. In some aspect, the encode report includes an XML/CSV file that details all tags, and what happened for the encoding attempts. If the tag was discovered, then encoding may be attempted immediately. For instance, in some aspect, the marking of the failure may include using a down-stream marking system, such as an inkjet printer, a hole punch, or a laser printer.

The encoder will then check to see whether the write was a success. If it was a success, then the encoding will be labeled a success, the discovery will be disabled, and the encoded result will be provided back to the encoder. The encoder will report the encoded result.

If the write of a tag was not a success, the encoder may mark that the encoding failed, disable discovery (e.g., via a standard command to an NFC reader), and then report the result received in the encode report as previously discussed. In some aspect, the encoder will then cause a downstream marker to mark the tag. For example, the downstream marker may also be triggered with a digital trigger. In some aspect, because the tag position is always tracked with optical sensors, the system may be able to detect when a failed tag has reached the marker, and trigger the marker to fire.

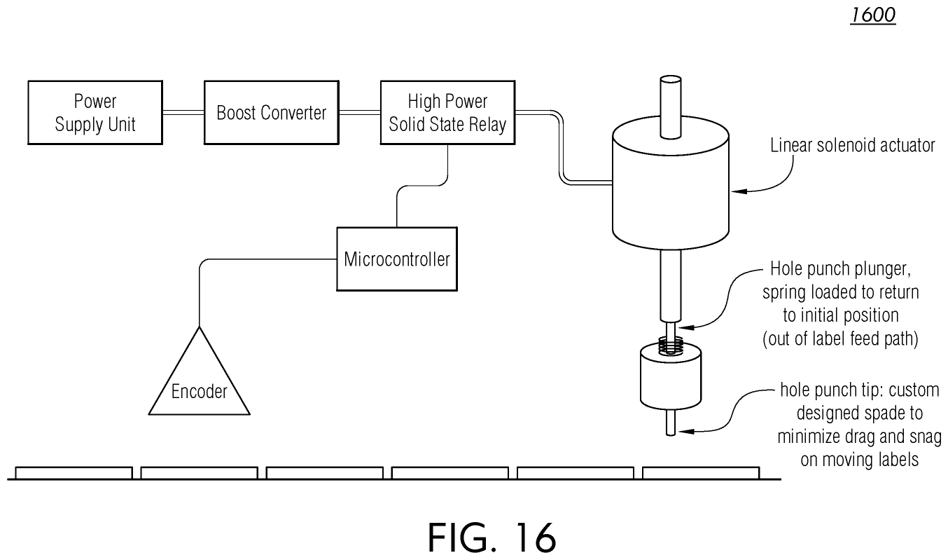

FIG. 16 illustrates an exemplary system 1600 having an exemplary marker, in accordance with an implementation of the present disclosure. The system 1600 may include a power supply unit, a boost converter, a high power solid state relay, a microcontroller, an encoder, and an electronic hole punch. The electronic hole punch may include a linear solenoid actuator, a hole punch plunger, and a hole punch tip.

The power supply unit provides the power for the electronic parts of the system 400, including at least one of the boost converter, the high power solid state relay, the microcontroller, the encoder, and the hole punch. The boost converter converts the energy from the power supply unit into use by the hole punch. The microcontroller indicates when the encoder should operate.

Along the bottom of the system is the label feed path where tags are fed along the system and pass underneath the encoder and the hole puncher. The tags should move in the direction such that they pass under the encoder first and the hole punch second.

In some aspect, the hole punch plunger may be spring loaded to return to an initial position so that the hole punch plunger is out of the label feed path. The hole punch tip can be a custom designed spade to minimize dragging and snagging moving labels. For instance, the tip may include serrated edges that start the cut, on the edges, and cut along a circle to ends of the cut. In some aspect, the cut may rather start on the tip of the paper path, and allow for the web to drag along the edges, using the moving web to aid the cut.

### EXAMPLES

### High Power Hole Punch

A hole punch can mark bad labels by punching a hole through the tags that failed to be properly encoded. Labels are often made with thick, high strength polymer materials. A hole punch according to an embodiment of the present disclosure can use a linear actuator solenoid (e.g., any electromechanical device that creates suitable linear motion), hooked up to a PSU, to boost converter, to an optional high energy reservoir capacitor. When triggered through a solid state relay, the reservoir discharges into the solenoid, resulting in a high voltage and current applied for a very short period of time. For example, the discharge can result in a high voltage of 200 watts over a short period of fifteen milliseconds.

The hole punch can be mounted over a moving web of labels. However, the hole punch needs to be configured to punch a hole in the moving web without stopping the web or significantly disrupting the movement of the web. This requires a critical high speed switch and design of the penetrating bit to mark the label without impeding the web.

Therefore, the hole punch itself needs to be triggered at the exact moment when the bad tag passes under the hole punch. Contemporary practices respond to this problem by using a linear encoder, that keeps track of the position of the web at all times. However, linear encoders often use pinching wheels.

In some aspect, the hole punch sits downstream of the printer and the encoder. Therefore, the system needs to identify when a tag needs its initial encoding and when a bad tag has reached the hole punch and needs to be marked. A through beam detector can be configured in the system to identify when the RFID tag passes underneath the encoder and a second through beam detector can be configured to identify when the RFID tag passes underneath the hole punch. For example, the beam detector can be configured to activate the hole punch when exposed to the RFID tag. The two beam detectors can act as sensors to derive the position of the bad tag, in order to also discover web direction, speed, and position, without actually contacting the web (e.g., by counting triggers: Trigger 1=label 1, trigger 2=label 2, etc.).

### RFID Barcode Verification

Referring to FIG. 17, in an aspect, an RFID barcode verification device 1700 (the components of which may or may not be all physically housed in a single housing) may be used to validate RFID tags and barcodes on an RFID label 1750, post printing thereof. The goal is to ensure, on every RFID tag exiting the printer, that: (1) the barcode is legible; (2) the RFID data is correct; and (3) the RFID data and barcode data match.

In an aspect, the verification device 1700 may be placed as an add-on to a label printer 1710, such as an RFID label printer (e.g., SATO® CL4NX RFID printer, etc.) or a non-RFID label printer (e.g., EPSON™ C7500 printer), but it could be placed on any printer or any device that helps generate or check an RFID data, a barcode data, or both. In some aspect, as printed RFID tags 1750 exit the printer 1710, the verification device 1700 will automatically isolate every tag and simultaneously scan the barcode and read the embedded RFID tag 1750. As such, the verification device 1700 will compare both datasets to verify that both match and are synchronized.

Once the verification device 1700 has been installed and properly configured, the systems and methods of the present disclosure may work independently from the printer 1710, automatically scanning every tag 1750 that passes through the verification device 1700 or the printer 1710. The verification device 1710 will only interfere with the print process when the printer system 1710 is not ready, or if an illegible barcode, a mis-encoded RFID tag 1750, or a mismatched barcode/RFID data combination is detected. Since the verification device 1700 will be designed with ease of use in mind, it may require minimal user intervention between label print jobs.

### Hardware

Still referring to FIG. 17, in an aspect, the verification device 1700 includes a microcontroller 1701 (e.g., a Flexstr8 Controller), which is communicably connected to, and which controls, commercially available barcode camera(s) 1702 and an RFID reader 1703. The microcontroller 1701 may be programmed to work with any barcode scanner 1702, depending on user preference. In an aspect, the camera 1702 is able to scan one-dimensional and two-dimensional barcodes, but it may also come pre-configured from the camera supplier to scan the barcode data outlined by the customer. For example, the customer may specify the type of barcode(s) to look for (SGTIN, UPC, etc.). The RFID reader 1703 will be able to singulate the same label 1750 being read by the camera 1702, and pull the EPC and TID data from the RFID label. For example, in an aspect, a combination of physical shielding (e.g., RF absorbers and reflectors), and selection algorithms (e.g., based on last tags seen, RFID read strength (RSSI), RFID read rate) may be used to perform tag singulation. As used herein, “singulate” or “tag singulation” refers to the act of isolating and reading the tag desired by the user.

The barcode data and EPC data will then immediately be compared to ensure they match, following an algorithm or lookup table provided or referenced by the user. In some aspect, the comparison may be done by translating the RFID EPC data into barcode data using an algorithm supplied by GS1 (a global standards creator), or by the customer. For example, one of the most common algorithms used in retail is the GS1 EPC Tag Data Standard. In an aspect, if the barcode is found to be illegible, the RFID tag found to be dead, or if the algorithm finds that the barcode data does not match the EPC data, then an alarm will be activated, and the printer 1710 paused. In some aspect, the printer 1710 may be communicably connected to the microcontroller 1701 via USB, LAN, dedicated IO ports, RS232, etc. For example, the alarm may be an audible one sounded by a speaker (not shown) connected to the microcontroller, or a visual or audio alert on the verifier (user)'s interface 1760 connected to a webserver 1740.

Alternatively, an automatic back-feed and overprint on the bad label or a downstream marker could strike out bad tags. For instance, the auto back-feed or overprint may be enabled with specific printer commands. In an aspect, the downstream marker may be a marker that is fired when the tag found to be faulty is under the RFID reader 1703. In some aspect, the downstream marker is fired by the microcontroller IO, and the microcontroller 1701 knows when to fire by counting the current label 1750 under the RFID reader 1703 at all times.

In an aspect, the verification device 1700 will be fully networked (i.e., communicably coupled to another computer device or a network node), in order to send verification data to the Nexgen servers 1760.

### Software

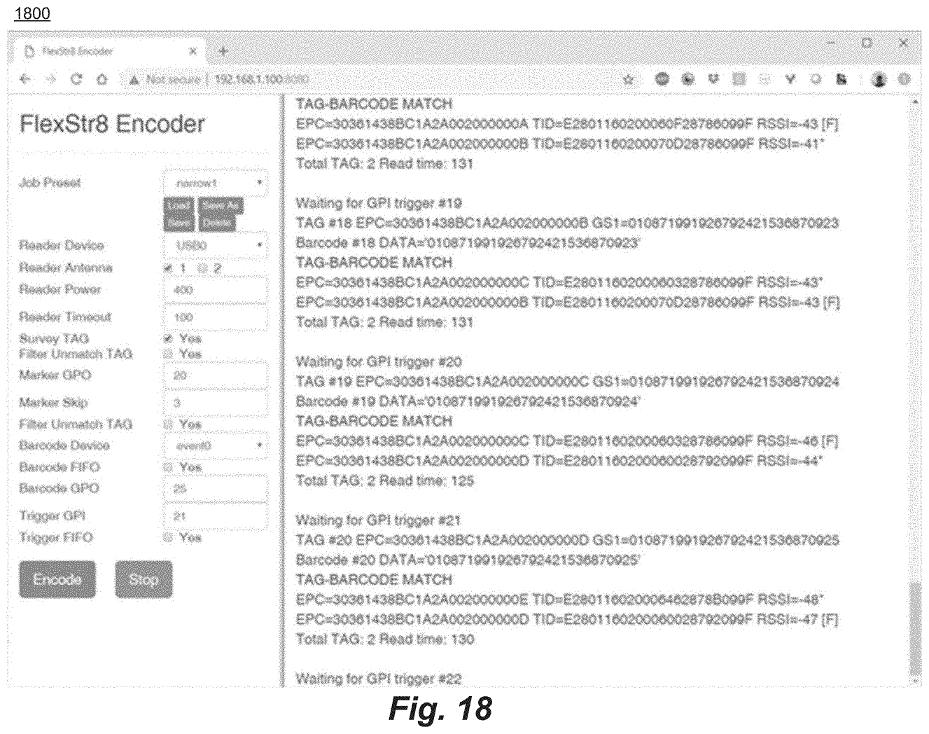

Referring to FIG. 18, in an aspect, the verification device can also generate a web server page 1800 for user interface 1740 (FIG. 17). Users can interface with this webpage 1800 to setup and configure the verifier device 1700, pull raw data, or view its real-time status. The advantage of using a webpage 1800 is that any user with an internet connected device and browser will be able to configure and monitor the verifier 1700. Users with elevated security could also edit the path (e.g., a path to an FTP server or anywhere where the user would like the data to be sent) where verification data is sent. Data is sensitive customer property. If it winds up in the wrong hands, it will likely result in a breach of contract. In some aspect, the verification device may also be version-controlled and upgraded from this portal 1800.

### Software Architecture

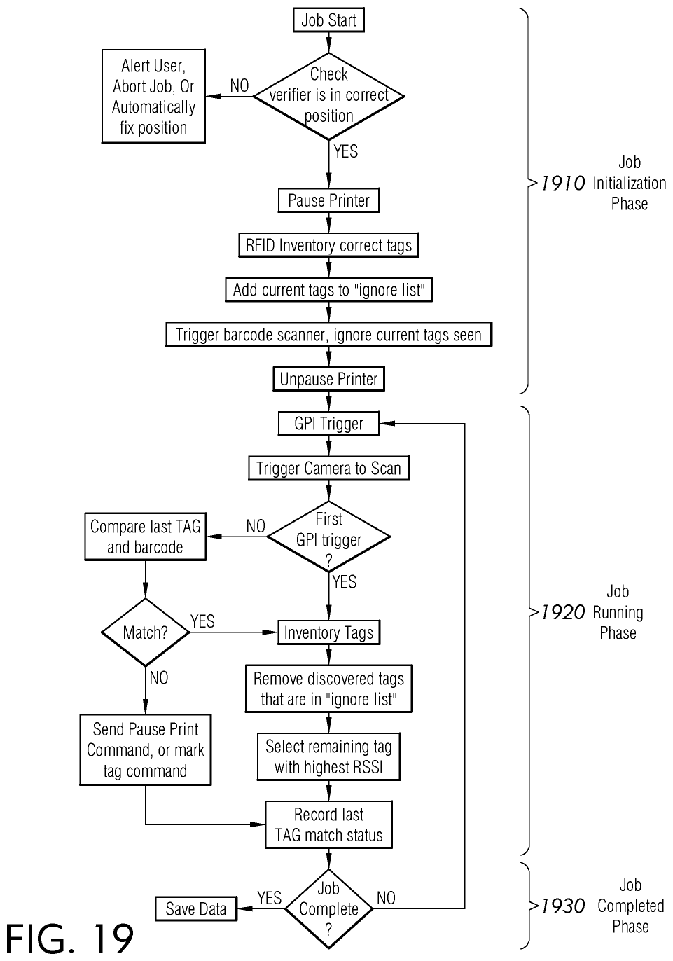

Referring to FIG. 19, the operation of the verifier device 1700 (FIG. 17) has 3 main states: Initialization, Running, and Completion.

Job Initialization Phase (1910):

When a user starts the operation of the verifier 1700, job initialization phase 1910 is the first phase it enters. During this phase, the verifier 1700 pauses the printer 1710 (FIG. 17), and runs system checks before arming itself to start verifying.

One of the first steps the verifier 1700 must perform is to prepare itself for tag singulation, i.e., the act of isolating one specific RFID tag to operate on. In an aspect, singulation may include creating or using an “ignore” list, e.g., a list of tags that may be ignored when deciding which tag is correct to singulate. When the operation of the verifier 1700 is started, the number of tags readable is indeterminate: it could be one, none, or several. For this reason, at job start, the RFID reader 1703 (FIG. 17) performs a standard inventory scan of all tags within the shielding of the verifier machine (see FIGS. 19A-19B) at a suitable preset power that may be found to work with a tag interrogation or a barcode scanning. In an aspect, the standard inventory scan may be performed using a standard RFID reader command, which would cause the RFID scanner 1703 to look for all available tags it can see, and cause the verifier 1700 (RFID scanner 1703) to list the scanned tag EPC and attributes.

All tags found at this step are added to the ignore list. That way, when the first tag 1750 (FIG. 17) in the job enters the verifier 1700, one may singulate it by inventorying the tags currently in the verifier 1700, and subtracting all tags in the ignore list.

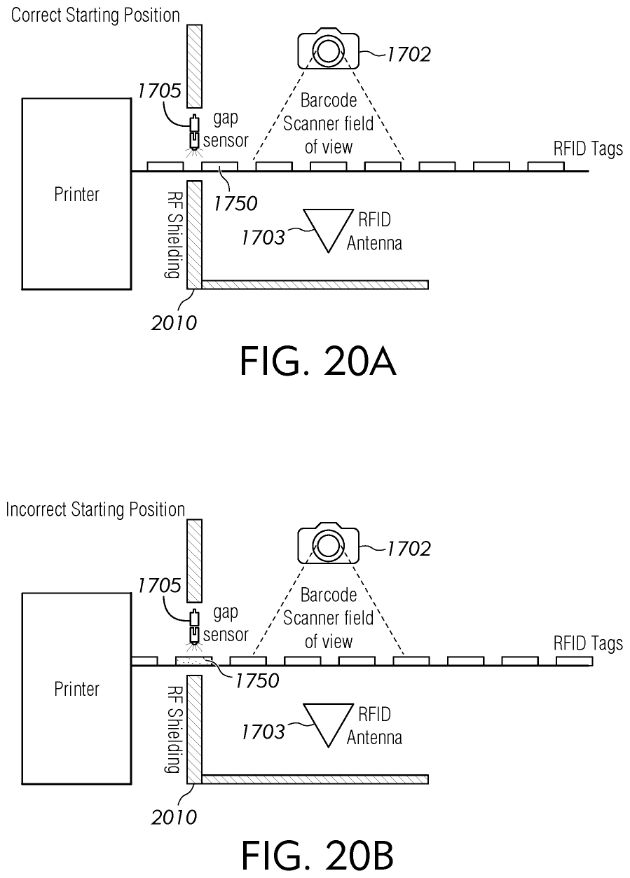

Reference is now made to FIGS. 20A-20B. Verifier positioning is also crucial for reliable tag singulation. In order to separate tags that are in the verifier 1700 as opposed to out of it, in an aspect, the method or system of the present disclosure may use RFID shielding 2010 (e.g., conductive metals, EMI absorbers, or a combination of both). A vulnerability in this phase is if the verifier 1700 is in a position where a tag 1750 is not fully shielded (shown in red in image in FIG. 20B). This could cause the tag 1750 to be readable or not for any number of reasons, including tag RSSI strength, a variable not in our control. If the verifier 1700 were to operate with respect to a tag 1750 under such circumstance, tag singulation would not occur reliably.

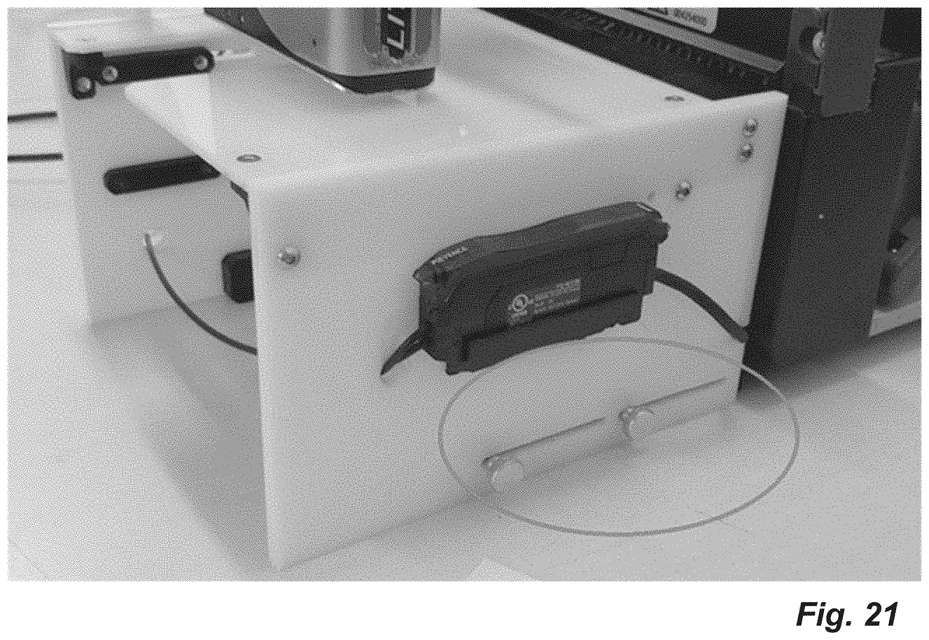

Referring to FIG. 21, in an aspect, the solution to such unreliable tag singulation may be to move the shielding to rest immediately under or proximate to a gap in adjacent labels. To enable this functionality, the RF shielding 2010 and RFID antenna 1703 (FIG. 20A) are mounted on rails (circled in red in FIG. 21), so that the verification device 1700 may slide and lock into a suitable position. This offers the verifier 1700 a clear distinction of labels completely within the shielding (e.g., FIG. 20A), and completely out of the shielding.

Referring back to FIGS. 20A-20B, in order to alert the verifier 1700 (users thereof) of whether the tag positioning is correct, in an aspect, on or more gap sensor(s) 1705 (also FIG. 17)(e.g., Keyence fiber optic gap sensor, etc.) may be positioned as close to, or immediately on top of, the shielding 2010. This offers some advantages: (1) the gap sensor glows red, so users can easily see it, and see if it is over a gap in the labels or not; (2) the gap sensor can detect if it, and thus the shielding, is currently over a gap; and/or (3) the gap sensor will alert (e.g., via digital signal) the encoder every time anew label has entered the verifier by triggering the verifier at the trailing edge of the label.

In some aspect, if the gap sensor (detector) 1705 detects a problem in the verifier positioning, it can alert the verifier 1700 to abort the job, and alert the user to move the verifier 1700 into an appropriate position.

It should be noted that a barcode scanner may face many of the same foregoing problems as an RFID reader, in terms of tag singulation. Hence, in some aspect, a barcode scanner may be designed to have its field of view terminate at the gap sensor 1705, allowing users to clearly visualize which barcodes can be seen, and which ones cannot. For example, in some aspect, the placement and angle of the barcode scanner may be made adjustable by the user using custom brackets. In an aspect, the gap sensor 1705 may include a red bar of a size visibly large enough to mark the start of what is in the field of view for the verifier 1700 (e.g., the field of view of the barcode scanner 1702). For example, the barcode camera 1702 may be hooked up to a computer display to visually display what is currently “seen” by the barcode camera 1702 in its field of view.

Assuming all initialization steps occur without error, in some aspect, the methods and systems of the present disclosure performing the verification process moves to an “armed” state. In this state, the systems and methods will attempt to verify all tags that pass through the verifier 1700. At this step, the verifier 1700 will un-pause the printer 1710 to start the job.

Additionally, a common setting in many label printers is a “feed to peel off position” function, whereby the printer always feed labels until a whole label exits entirely out of the printer. Such function enables users to easily peel off the label thus printed, but it may also mean that at a stationary state, a label is fed by the printer (i.e., the printer drives the label web outwardly) until the gap is exposed past the printer exit. In some aspect, the shielding 2010 and gap sensor 1705 may be placed right at the printer exit, such that the shielding will always be in the ideal position to run the initialization step, regardless of the label size or pitch. For example, the shielding 2010 may be fixed in such position, so that the user would not need to adjust the shielding position (see correct/incorrect starting positions in FIGS. 20A-20B).

Alternatively, in some aspect, the printer 1710 may output a signal (e.g., via its communication or IO port) to the verifier 1700 or the user interface 1740 every time a label has been printed, instead of using a gap sensor 1705.

Still further, in some embodiment, the printer face may be used as the shielding 2010, rather than a separate shielding.

Job Running Phase (1920):

In the job running phase 1920, the verifier 1700 passively waits for labels to enter the verification region, and automatically verifies tags as they pass. In an aspect, this phase is triggered by the gap sensor 1705, which is normally placed at the edge of the verifier's (barcode scanner 1702) field of view. The gap sensor 1705 triggers the barcode scanner 1702 and RFID reader 1703 at the falling edge of the label, when the label 1750 has completely entered the (operational or detection range of) verifier 1700.

During every job running cycle, the verifier 1700 checks if the singulated RFID tag's EPC data matches the tag's barcode data. In an aspect, this match could be based on an algorithm (such as the widely adopted ken-traub EPC decoder algorithm), a custom algorithm, or a lookup table. In some aspect, more quality checks could be added to this step, such as barcode grading, RSSI threshold, tag lock status, etc.

Job Completion Phase (1930):

When the verification job is stopped, or when the user stops the verifier 1700, the methods and systems of the present disclosure prepares a job summary in the job completion phase 1930. The verifier 1700 may send the verification data to an FTP server (e.g., via common FTP data push) to be backed up.

Upgrades:

The verification device may verify a single label, or it may verify more than one label at a time. It is Flexstr8's goal is to build an adaptable unit. The control unit 1701 may functionally communicate with any USB barcode scanner, USB RFID reader, and gap sensor.

In some implementation, in order to accommodate verification of additional labels, the user may select presets (e.g., tag verification parameters such as antenna power, tag size, read time, etc.), using a web app communicably connected to the controller 1701 and accessible via the user interface 1740. In some aspect, the preset may adjusts the RFID read power and read time to those that are found empirically to read and singulate tags in a most reliable fashion. In some aspect, a marker may also be added and controlled (e.g., via a verifier IO port) by the verification device 1700. For example, an optional marker may be communicably connected to and reside downstream of the verifier 1700, and fires over tags that are found to be bad, mis-encoded, misprinted, etc.

In some aspect, a success criteria for the tag verification may include one or more of the following:

Print 1000 pre-agreed upon barcodes/RFID tags with no more than 10 known bad tags. Let no more than 1 through.

Successfully pull barcode and EPC data of all 1000 tag prints with no more than one misread on either barcode, EPC, or TID.

Successfully upload EPC, TID, and UPC data to Nexgen FTP location.

Successfully test the pause and resume function with a production operator.

Successfully test the strikeout functionality.

Demonstrate and validate that production operator(s) understand how to operate the equipment, setup jobs, and change any required configurations necessary based on anew job.

Demonstrate and validate that production operator(s) can complete basic troubleshooting, and understand how to properly obtain support and escalate issues.

While various examples of the present disclosure have been described above, it should be understood that they have been presented by way of example only, and not limitation. Numerous changes to the disclosed examples can be made in accordance with the disclosure herein without departing from the spirit or scope of the disclosure. Thus, the breadth and scope of the present disclosure should not be limited by any of the above described examples. Rather, the scope of the disclosure should be defined in accordance with the following claims and their equivalents.

Although the disclosure has been illustrated and described with respect to one or more implementations, equivalent alterations and modifications will occur to others skilled in the art upon the reading and understanding of this specification and the annexed drawings. In addition, while a particular feature of the disclosure may have been disclosed with respect to only one of several implementations, such feature may be combined with one or more other features of the other implementations as may be desired and advantageous for any given or particular application.

The terminology used herein is for the purpose of describing particular examples only and is not intended to be limiting of the disclosure. As used herein, the singular forms “a,” “an,” and “the” are intended to include the plural forms as well, unless the context clearly indicates otherwise. Furthermore, to the extent that the terms, “including,” “includes,” “having,” “has,” “with,” or variants thereof are used in either the detailed description and/or the claims, such terms are intended to be inclusive in a manner similar to the term, “comprising.”

Unless otherwise defined, all terms (including technical and scientific terms) used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

What is claimed is:

1. A computer-implemented method for synchronizing a radio frequency identification (RFID) label printing and encoding using a label printer and an RFID encoder communicably connected thereto, the method comprising:
scanning an image of a serialization data printed by the label printer on one of a plurality of RFID labels on a moving roll;
receiving, by the RFID encoder, the serialization data;
reading a transponder ID (TID) of the one of the plurality of RFID labels on the moving roll;
transforming the serialization data into an encode data; and
mask encoding, by the RFID encoder, the one of the plurality of RFID labels with the encode data, wherein the mask encoding is synchronized with the reading.

2. The computer-implemented method according to claim 1, further comprising, prior to the scanning:
receiving the serialization data from a user; and
printing, by the label printer, the plurality of RFID labels including the image of the serialization data.

3. The computer-implemented method according to claim 1, wherein the image is a barcode on the one of the plurality of RFID labels printed by the label printer.

4. The computer-implemented method according to claim 3, wherein the barcode is a one-dimensional barcode.

5. The computer-implemented method according to claim 3, wherein the barcode is a two-dimensional barcode.

6. The computer-implemented method according to claim 1, wherein the mask encoding includes encoding a TID mask into the one of the plurality of RFID labels.

7. The computer-implemented method according to claim 1, wherein the encode data is EPC data.

8. The computer-implemented method according to claim 1, further comprising receiving a barcode offset from a user.

9. The computer-implemented method according to claim 1, further comprising providing an ordered list of TIDs in the plurality of RFID labels.

10. The computer-implemented method according to claim 1 further comprising:
determining that the mask encoding of the one of the plurality of RFID labels is not successful;
recording a tag index of the one of the plurality of RFID labels as bad; and
initiating a bad label process.

11. A system for synchronizing a radio frequency identification (RFID) label printing and encoding using a label printer and an RFID encoder communicably connected thereto, comprising:
a processor,
a memory communicably connected to the processor storing a set of instructions thereon that, when executed by the processor, causes the RFID encoder to perform operations comprising:
scanning an image of a serialization data printed by the label printer on one of a plurality of RFID labels on a moving roll;
receiving the serialization data;
reading a transponder ID (TID) of the one of the plurality of RFID labels on the moving roll;
transforming the serialization data into an encode data; and
mask encoding the one of the plurality of RFID labels with the encode data, wherein the mask encoding is synchronized with the reading.

12. The system of claim 1, wherein the set of instructions, when executed by the processor, further causes the RFID encoder to, prior to the scanning, perform the operations comprising:
receiving the serialization data from a user; and
printing, by the label printer, the plurality of RFID labels including the image of the serialization data.

13. The system according to claim 11, wherein the image is a barcode on the one of the plurality of RFID labels printed by the label printer.

14. The system according to claim 13, wherein the barcode is a one-dimensional barcode.

15. The system according to claim 13, wherein the barcode is a two-dimensional barcode.

16. The system according to claim 11, wherein the mask encoding includes encoding a TID mask into the one of the plurality of RFID labels.

17. The system according to claim 11, wherein the encode data is EPC data.

18. The system according to claim 11, further comprising receiving a barcode offset from a user.

19. The computer-implemented method according to claim 1, wherein the set of instructions, when executed by the processor, further causes the RFID encoder to perform the operation comprising providing an ordered list of TIDs in the plurality of RFID labels.

20. The system according to claim 11, wherein the set of instructions, when executed by the processor, further causes the RFID encoder to perform the operations comprising:
determining that the mask encoding of the one of the plurality of RFID labels is not successful;
recording a tag index of the one of the plurality of RFID labels as bad; and
initiating a bad label process.
